(19) United States
(12) Patent Application Publication
(10) Pub. No.: US 2013/0293520 A1
(43) Pub. Date: Nov. 7, 2013

(54) DISPLAY DRIVING DEVICE AND METHOD FOR DRIVING DISPLAY PANEL

(71) Applicant: NOVATEK MICROELECTRONICS CORP., Hsinchu (TW)

(72) Inventors: Sheng-Wen Hsiao, Changhua County (TW); Wen-Pin Tsai, Hsinchu City (TW)

(73) Assignee: NOVATEK MICROELECTRONICS CORP., Hsinchu (TW)

(21) Appl. No.: 13/753,533

(22) Filed: Jan. 30, 2013

(30) Foreign Application Priority Data
May 7, 2012 (TW) 101116207

(51) Int. Cl. G09G 3/02

(52) U.S. Cl. CPC G09G 3/02
USPC 345/204

(57) ABSTRACT

A display driving device and a method for driving a display panel are provided. The display driving device includes the display panel and a display driver. The display panel includes a plurality of pixel units and a plurality of multiplexers. Each of the multiplexers is disposed with N data lines. The display driver provides a plurality of display data strings and a plurality of selection signals to the multiplexers to control the multiplexers according to the selection signals to receive and sequentially output the display data of the pixel units. Each of the display data strings forms two display data sets of different polarities in a same scan line, and the display data sets include the display data of at least one pixel unit. Thereby, the polarity inversion number of the display data and accordingly the power consumption can be reduced when the display driving device drives the pixel units.

### CROSS-REFERENCE TO RELATED APPLICATION

This application claims the priority benefit of Taiwan application serial no. 101116207, filed on May 7, 2012. The entirety of the above-mentioned patent application is hereby incorporated by reference herein and made a part of this specification.

### BACKGROUND OF THE INVENTION

1. Field of the Invention

The invention generally relates to a display driving device and a driving method thereof, and more particularly, to a display driving device with reduced polarity inversion number of display data and accordingly reduced power consumption and a method for driving a display panel.

2. Description of Related Art

Along with the development of the electronic industry, flat panel displays have become today's major display devices. Liquid crystal display (LCD) is one of the most popular and mature flat panel display devices. In particular, low-temperature polysilicon (LTPS) LCD is presently the major LCD product manufactured by various manufacturers thanks to its fast display speed, high brightness, and high resolution, etc.

FIG. 1 is a diagram illustrating the hardware structure of a LCD 100. Referring to FIG. 1, the LCD 100 includes a display driver 110 and a display panel 120. Herein only the part of the LCD 100 related to the present example is illustrated, and other parts of the LCD 100 can be easily deduced therefore is not illustrated. The multiplexers 130 receive display data strings (for example, display data having different polarities and representing different colors (red, green, and blue)) provided by output lines (for example, output lines SOUT[X] and SOUT[X+1]) of source driver pairs 140 in the display driver 110. The display driver 110 controls the multiplexers 130 with selection signals (for example, a red pixel unit selection signal RSW, a green pixel unit selection signal GSW, and a blue pixel unit selection signal BSW) to provide the display data strings to be displayed by the pixel units to the corresponding data lines (for example, red data lines DR[X]-DR[X+1], green data lines DG[X]-DG[X+1], and blue data lines DB[X]-DB[X+1]) in a timeshared and sequential way. Meanwhile, the display driver 110 controls the scan lines (for example, the scan lines LINE[M] and LINE[M+1]) to drive the pixel units on the display panel 120. In the present example, X, N, and M are all positive integers.

Due to the characteristic of polysilicon liquid crystal, when the display driver 110 provides display data to the display panel 120, it should let the liquid crystals to alternatively receive display data of different polarities. Presently, dot inversion and column inversion are the two major mechanisms for driving the display panel 120. In a general driving technique, because the source driver pairs 140 repeatedly output display data with different polarities (i.e., repeatedly reverse the polarity of the display data strings and then output the display data strings), excess power is consumed inside the source driver pairs 140. On the other hand, because the output lines SOUT[X] and SOUT[X+1] of the source driver pairs 140 come with parasitic capacitance, more power is consumed when the display driver 110 supplies the display voltage.

### SUMMARY OF THE INVENTION

Accordingly, the invention is directed to a display driving device and a method for driving a display panel, in which the sequence for providing data with different polarities to pixel units and the startup timing of multiplexers are re-arranged so that when the display driving device drives the pixel units, the polarity inversion number of the display data is reduced and accordingly less power is consumed.

The invention provides a display driving device including a display panel and a display driver. The display panel includes a plurality of pixel units and a plurality of multiplexers. Display data is provided to a plurality of columns of the pixel units via a plurality of data lines. Each of the multiplexers is disposed with N data lines, wherein N is a positive integer grater than or equal to 2. The display driver is coupled to the multiplexers. The display driver provides a plurality of display data strings and a plurality of selection signals to the multiplexers, so as to control the multiplexers to receive and sequentially output the display data of the pixel units according to the selection signals. Herein each of the display data strings forms two display data sets of different polarities in the same scan line, and the display data sets include the display data of at least one pixel unit.

According to an embodiment of the invention, the display data sets of each of the display data strings in adjacent time slots of adjacent scan lines have the same polarities.

The invention also provides a method for driving a display panel. The method includes following steps. The display panel is provided, wherein the display panel includes a plurality of multiplexers and a plurality of pixel units. Display data is respectively provided to a plurality of columns of the pixel units via a plurality of data lines, and each of the multiplexers is disposed with N data lines, wherein N is a positive integer greater than or equal to 7. A plurality of display data strings and a plurality of selection signals are provided to the multiplexers, wherein each of the display data strings forms two display data sets of different polarities in the same scan line, and the display data sets include the display data of at least one pixel unit. The multiplexers are controlled to receive and sequentially output the display data of the pixel units according to the selection signals.

As described above, in a display driving device provided by an embodiment of the invention, the type of the multiplexers and the display data driving mechanism adopted in the display panel are determined, and the sequence of providing display data strings to the multiplexers and the startup timing of the multiplexers are re-arranged, so that the polarity inversion number of the display data, and accordingly the power consumption, can be reduced when the display driver drives the pixel units.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating the hardware structure of a liquid crystal display (LCD).

FIG. 2 is a diagram illustrating how a display panel is driven through a 1-dot inversion mechanism.

FIG. 3 is a diagram illustrating how a display driving device works with the 1-dot inversion mechanism according to a first embodiment of the invention.

FIG. 4 is a diagram illustrating how a display panel is driven through a 2-dot inversion mechanism.

FIG. 5 is a diagram illustrating how a display driving device works with the 2-dot inversion mechanism according to a second embodiment of the invention.

FIG. 6 is a diagram illustrating how a display panel is driven through a column inversion mechanism.

FIG. 7 is a diagram illustrating how a display driving device works with the column inversion mechanism according to a third embodiment of the invention.

FIG. 8 is a diagram illustrating the hardware structure of a display driving device according to a fourth and a fifth embodiments of the invention.

FIG. 9 is a diagram illustrating how a display panel is driven through the 1-dot inversion mechanism.

FIG. 10 is a diagram illustrating how a display driving device works with the 1-dot inversion mechanism according to the fourth embodiment of the invention.

FIG. 11 is a diagram illustrating how a display panel is driven through the column inversion mechanism.

FIG. 12 is a diagram illustrating how a display driving device works with the column inversion mechanism according to the fifth embodiment of the invention.

FIG. 13 is a diagram illustrating how a display panel is driven through the 2-dot inversion mechanism.

FIG. 14 is a diagram illustrating how a display driving device works with the 2-dot inversion mechanism according to the sixth embodiment of the invention.

FIG. 15 is a flowchart of a method for driving a display panel according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

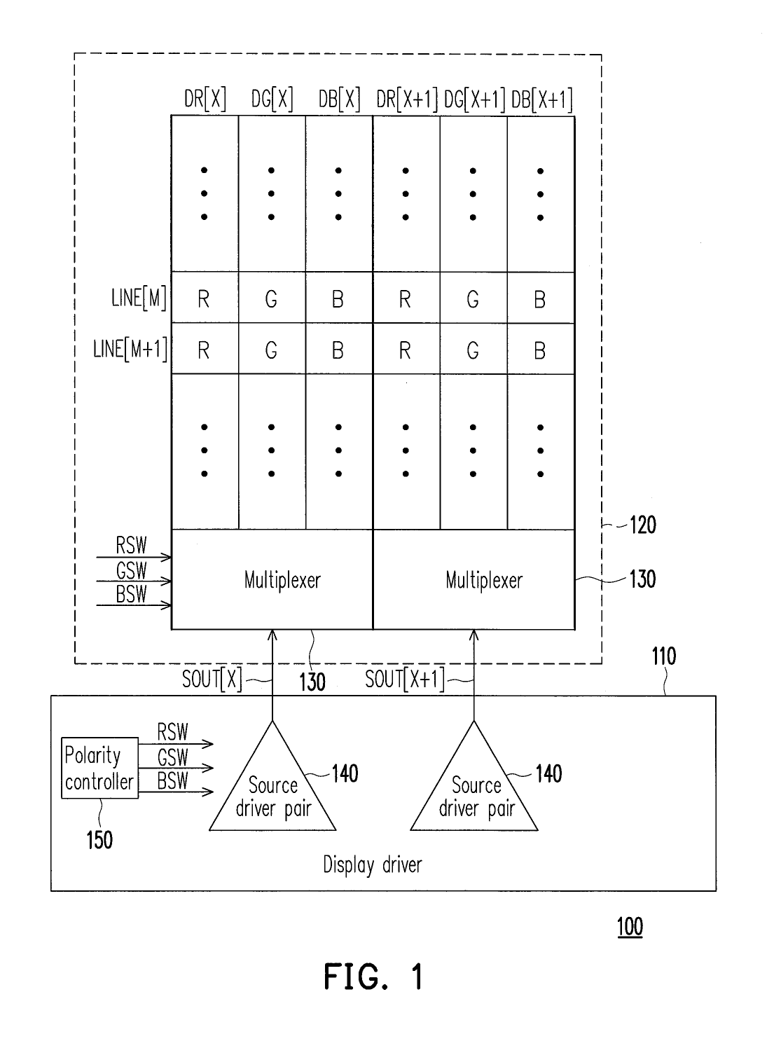

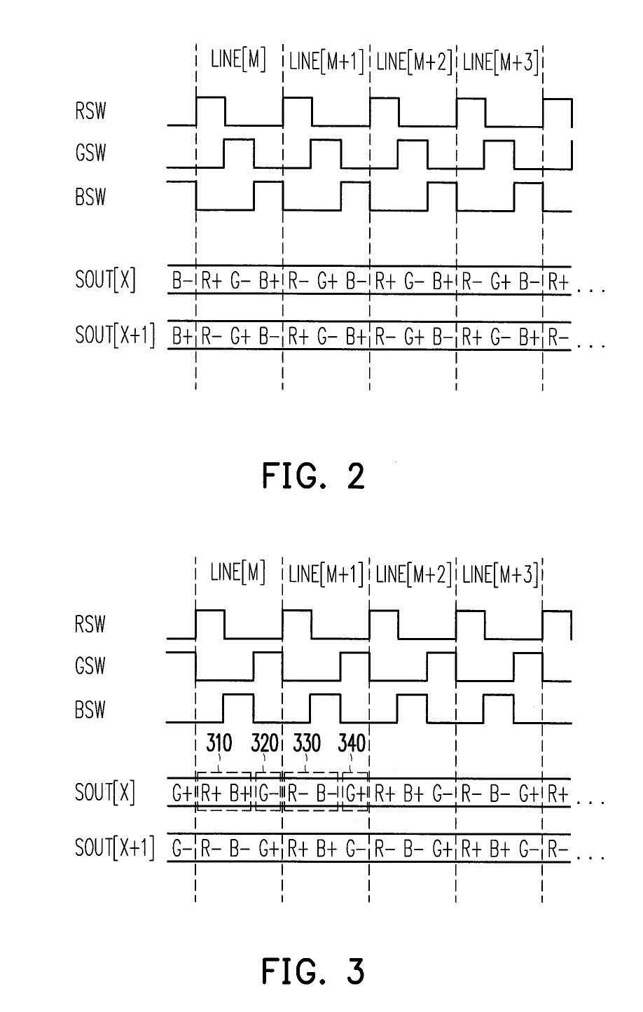

FIG. 2 is a diagram illustrating how a display panel 120 is driven through a 1-dot inversion mechanism. In the present embodiment, the liquid crystal display (LCD) 100 illustrated in FIG. 1 may also be referred to as a display driving device 100, and which, along with the display panel 120 illustrated in FIG. 2, works with a 1-dot inversion mechanism. Referring to both FIG. 1 and FIG. 2, the display driver 110 generates the selection signals RSW, GSW, and BSW in FIG. 2 by using a polarity controller 150, and meanwhile, transmits display data strings to the multiplexers 130 via the output lines SOUT[X] and SOUT[X+1]. Herein the display data string may be composed of the red positive display data R+, the green negative display data G−, and the blue positive display data B+ in FIG. 2. During the enabled period of the scan line LINE[M], the multiplexers 130 sequentially transmit data in the display data string to the corresponding red pixel units R, green pixel units G, and blue pixel units B respectively via the data lines DR[X], DG[X], and DB[X].

Thereby, the source driver pairs 140 repeatedly output display data of different polarities (i.e., repeatedly reverse the polarity of data in the display data string and then output the data) in a high voltage level state, and accordingly excess power is consumed inside the source driver pairs 140. On the other hand, because the output lines SOUT[X] and SOUT[X+1] of the source driver pairs 140 come with parasitic capacitance, more power is consumed when the display driver 110 supplies the display voltage.

In order to prevent excess power from being consumed in the display driver 110 for reversing the polarity of display data when the display driving device 100 transmits display data strings, in a display driving device 100 provided by an embodiment of the invention, the type of the multiplexers and the display data driving mechanism adopted in the display panel 120 are determined and the sequence of providing display data strings to the multiplexers 130 and the selection signals are re-arranged, so that the polarity inversion number of the display data, and accordingly the power consumption, can be reduced when the display driver 110 drives the pixel units. Below, several embodiments of the invention will be described in detail with reference to accompanying drawings.

### First Embodiment

The present embodiment will be described by taking the display driving device 100 illustrated in FIG. 1 as an example. The display driving device 100 includes the display panel 120 and the display driver 110. The display panel 120 includes a plurality of pixel units and a plurality of multiplexers 130. These pixel units are arranged into an array, and there is a pixel unit at each intersection point of the data lines (for example, the data lines DR[X], DG[X], DB[X], DR[X+1], DG[X+1], and DB[X+1]) and the scan lines (for example, the scan lines LINE[M] and LINE[M+1]). These pixel units may be red pixel units R, green pixel units G, and blue pixel units B. In other words, each column of the pixel units is controlled by the corresponding scan line, and display data is provided to each column of the pixel units via the corresponding data line.

Each of the multiplexers 130 is disposed with N data lines (for example, in FIG. 1, each multiplexer 130 is disposed with 3 data lines), wherein N is a positive integer greater than or equal to 2. Namely, the display panel 120 adopts 1:3 multiplexers 130. In other embodiments, the multiplexers 130 may also be 1:2, 1:6, or other types of multiplexers. Following embodiments of the invention will be described by focusing on 1:3 and 1:6 multiplexers, and those skilled in the art may also use other types of multiplexers to realize the spirit of the invention. However, the adoption of other types of multiplexers will not be described herein.

The control terminals of the multiplexers 130 receive selection signals RSW, GSW, and BSW, and the input terminals of the multiplexers 130 are coupled to the output lines (for example, the output lines SOUT[X] and SOUT[X+1]) of the source driver pairs 140. The display driver 110 is coupled to the multiplexers 130, and which respectively provides a plurality of display data strings and a plurality of selection signals to the multiplexers 130, so as to control the multiplexers 130 to receive and sequentially output the display data of the pixel units according to the selection signals.

In the present embodiment, display data of different polarities transmitted on the output lines SOUT[X] and SOUT[X+1] is generally referred to as display data strings. Each display data string forms two display data sets of different polarities during the enabled period of the same scan line, and these display data sets include the display data of at least one pixel unit. In addition, the selection signals RSW, GSW, and BSW are adjusted with the output sequence of the display data so that embodiments compliant with the spirit of the invention can be accomplished without changing the hardware structure of the display panel 120.

FIG. 3 is a diagram illustrating how the display driving device 100 works with the 1-dot inversion mechanism according to the first embodiment of the invention. Referring to FIG. 3, to reduce the polarity inversion number of display data transmitted by the source driver pairs 140 on the output lines SOUT[X] and SOUT[X+1], in the present embodiment, display data (for example, the positive red data R+, the negative green data G−, and the positive blue data B+) during the enabled period of the same scan line (for example, the scan line LINE[M]) are grouped into a positive display data set (for example, 310 in FIG. 3) and a negative display data set (for example, 320 in FIG. 3) of different polarities. Namely, display data of the same polarity is arranged in adjacent time slots so that such display data of the same polarity can be sequentially transmitted.

In the method illustrated in FIG. 2 for driving the display panel 120, the source driver pairs 140 have to reverse the polarity of the display data twice (i.e., reverse the polarity to G− after transmitting R+, and reverse the polarity to B+ after transmitting G−). While in the method illustrated in FIG. 3, the polarity of the display data in only reversed once (i.e., B+ is directly transmitted after R+ is transmitted, and the polarity is reversed to G− after B+ is transmitted), so that the number of times that the source driver pairs 140 reverse the polarity of the display data is reduced. In addition, besides the sequence of the display data strings, the display driver 110 also adjusts the enabling waveforms of the selection signals RSW, GSW, and BSW, so that after the display panel 120 receives related signals in FIG. 3, it still presents an image same as that in the situation illustrated in FIG. 2.

Additionally, the display data sets of the display data string on the output line SOUT[X] in adjacent time slots of adjacent scan lines also have the same polarity, so that the polarity inversion number of the display data is further reduced For example, in FIG. 3, the display data is also grouped into a positive display data set 330 and a negative display data set 340 during the enabled period of the scan line LINE[M+1], and the display data sets 320 and 330 are both negative at where the enabled period of the scan line LINE[M] meets the enabled period of the adjacent scan line LINE[M+1]. In the driving method illustrated in FIG. 2, the source driver pairs 140 need to reverse the polarity of the display data 6 times during the enabled periods of the adjacent scan lines LINE[M] and LINE[M+1] in FIG. 2. While in the driving method illustrated in FIG. 3, the source driver pairs 140 need only to reverse the polarity of the display data 2 or 3 times during the enabled periods of the adjacent scan lines LINE[M] and LINE[M+1].

Thereby, in the present embodiment, when the display driving device 100 adopts 1:3 (i.e., N=3) multiplexers 130 and drives the display panel 120 through 1-dot inversion, the positive display data set 310 of each display data string in the first data line LINE[M] is sequentially display data of the red positive polarity (R+) and display data of the blue positive polarity (B+), and the negative display data set 320 thereof is display data of the green negative polarity, as shown in FIG. 3. Correspondingly and sequentially, the negative display data set 330 in the second data line LINE[M+1] is sequentially display data of the red negative polarity (R−) and display data of the blue negative polarity (B−), and the positive display data set 340 is display data of the green positive polarity (G+). Namely, a first display data string on the output line SOUT[X] is always sequentially composed of display data of the red positive polarity (R+), the blue positive polarity (B+), and the green negative polarity (G−) in the first scan line LINE[M] and sequentially composed of display data of the red negative polarity (R−), the blue negative polarity (B−), and the green positive polarity (G+) in the second scan line LINE[M+1]. A second display data string on the output line SOUT[X+1] is similar to the first display data string.

### Second Embodiment

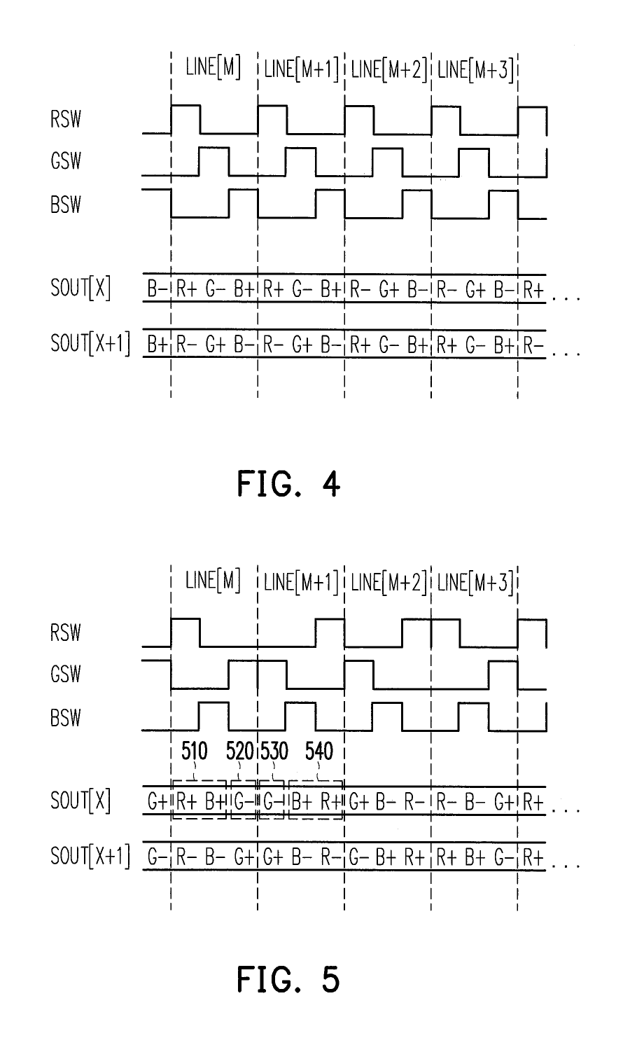

FIG. 4 is a diagram illustrating how a display panel 120 is driven through a 2-dot inversion mechanism. FIG. 5 is a diagram illustrating how a display driving device 100 works with the 2-dot inversion mechanism according to the second embodiment of the invention. The present embodiment is similar to the embodiment described above, and the difference between the two embodiments is that in the second embodiment, 1:3 multiplexers are adopted and the display panel 120 in FIG. 1 is driven through 2-dot inversion. The timing of display data strings conventionally arranged through 2-dot inversion is illustrated in FIG. 4 and will not be described herein.

Referring to FIG. 5, in the present embodiment, display data (for example, the positive red data R+, the negative green data G−, and the positive blue data B+) during the enabled period of a same scan line (for example, the scan line LINE[M]) is grouped into a positive display data set (for example, 510 having the display data R+ and B+) and a negative display data set (for example, 520 having the display data G−) of different polarities. Namely, display data of the same polarity is arranged in adjacent time slots so that such display data of the same polarity can be sequentially transmitted. During the enabled period of the scan line LINE[M+1], the display data R+, G−, and B+ is grouped into a negative display data set (for example, 530 having the display data G−) and a positive display data set (for example, 540 having the display data B+ and R+). Additionally, the display data sets 520 and 530 during the enabled period of adjacent scan lines have the same negative data.

Thereby, when the display driving device 100 adopts 1:3 (i.e., N=3) multiplexers 130 and drives the display panel 120 through 2-dot inversion, a first display data string on the output line SOUT[X] is sequentially composed of display data of the red positive polarity (R+), the blue positive polarity (B+), and the green negative polarity (G−) in the first scan line LINE[M], display data of the green negative polarity (G−), the blue positive polarity (B+), and the red positive polarity (R+) in the second scan line LINE[M+1], display data of the green positive polarity (G+), the blue negative polarity (B+), and the red negative polarity (R−) in the third scan line LINE[M+2], and display data of the red negative polarity (R−), the blue negative polarity (B−), and the green negative polarity (G−) in the fourth scan line LINE[M+3]. Correspondingly, a second display data string on the output line SOUT[X+1] has the same arrangement regarding the color of the display data as the first display data string. However, the display data in the second display data string and the display data in the first display data string have reversed polarities.

### Third Embodiment

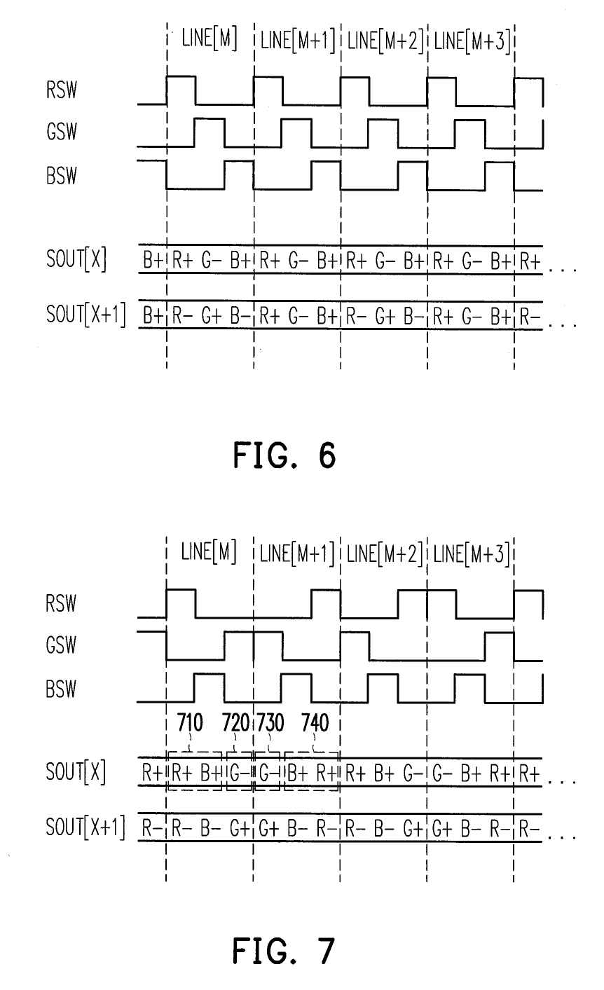

FIG. 6 is a diagram illustrating how a display panel 120 is driven through a column inversion mechanism. FIG. 7 is a diagram illustrating how a display driving device 100 works with the column inversion mechanism according to the third embodiment of the invention. The present embodiment is similar to the embodiment described above, and the difference between the two embodiments is that in the third embodiment, 1:3 multiplexers are adopted and the display panel 120 in FIG. 1 is driven through column inversion. The timing of display data strings conventionally arranged through column inversion is illustrated in FIG. 6 and will not be described herein.

Referring to FIG. 7, similar to that in foregoing embodiment, the display data R+, G−, and B+ during the enabled period of a same scan line (for example, the scan line LINE[M]) is grouped into a positive display data set (for example, 710 having the display data R+ and B+) and a negative display data set (for example, 720 having the display data G−) of different polarities. During the enabled period of the scan line LINE[M+1], the display data R+, G−, and B+ is grouped into a negative display data set (for example, 730 having the display data G−) and a positive display data set (for example, 740 having the display data B+ and R+). The display data sets 720 and 730 during the enabled periods of adjacent scan lines LINE[M] and LINE[M+1] have the same negative data.

In other words, a first display data string on the output line SOUT[X] is sequentially composed of display data of the red positive polarity (R+), the blue positive polarity (B+), the green negative polarity (G−) in the first scan line LINE[M] and display data of the green negative polarity (G−), the blue positive polarity (B+), and the red positive polarity (R+) in the second scan lineLINE[M+1]. Correspondingly, a second display data string on the output line SOUT[X+1] has the same arrangement regarding the color of the display data as the first display data string. However, the display data in the second display data string and the display data in the first display data string have reversed polarities.

### Fourth Embodiment

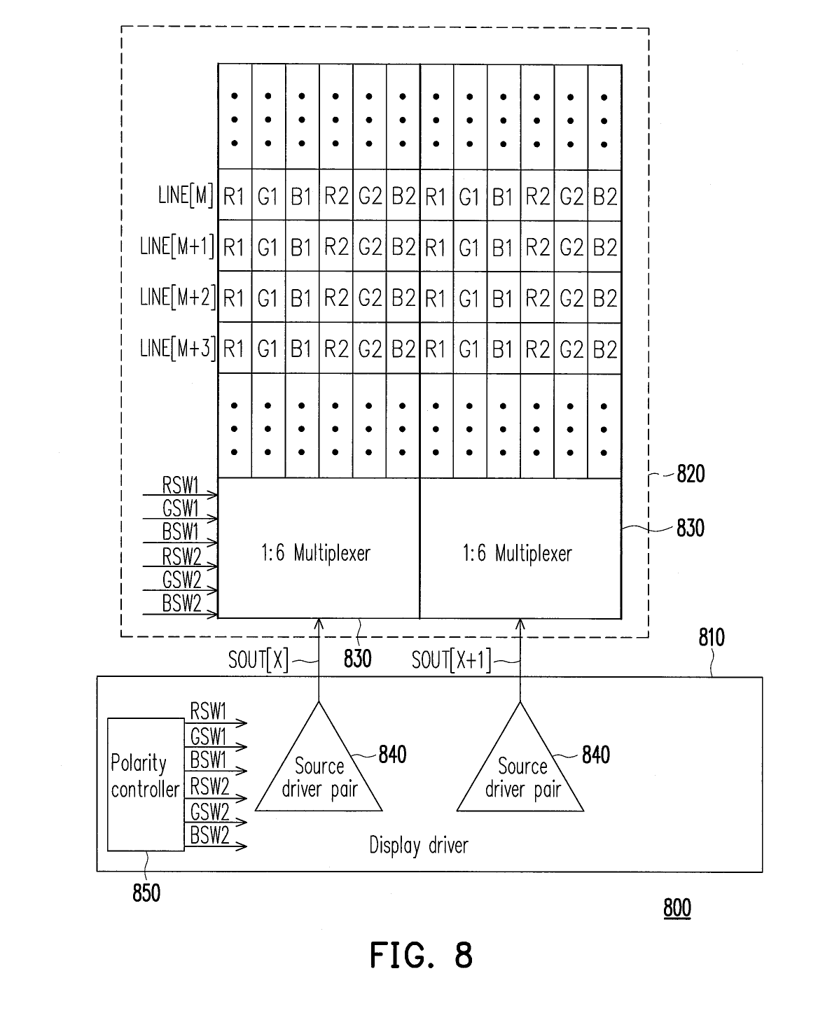

FIG. 8 is a diagram illustrating the hardware structure of a display driving device 800 according to a fourth and a fifth embodiments of the invention. Similar to that illustrated in FIG. 1, the display driving device 800 includes a display panel 820 and a display driver 810. The display driver 810 includes source driver pairs 840 and a polarity controller 850. The display panel 820 includes a plurality of pixel units and a plurality of multiplexers 830. Herein the display driving device 800 is described as a low-temperature polysilicon (LTPS) LCD. However, the invention is not limited thereto. Unlike that in FIG. 1, the display panel 820 in the present embodiment adopts 1:6 multiplexers 830. Namely, each multiplexer 830 is disposed with 6 data lines and receives a plurality of control signals (for example, the control signals RSW1-RSW2, GSW1-GSW2, and BSW1-BSW2). Accordingly, each multiplexer 830 can provide display data to a first set of color pixel units (i.e., the red pixel units R1, the green pixel units G1, and the blue pixel units B1) and a second set of color pixel units (the red pixel units R2, the green pixel units G2, and the blue pixel units B2). Other aspects of the embodiment can be referred to foregoing embodiments therefore will not be described herein.

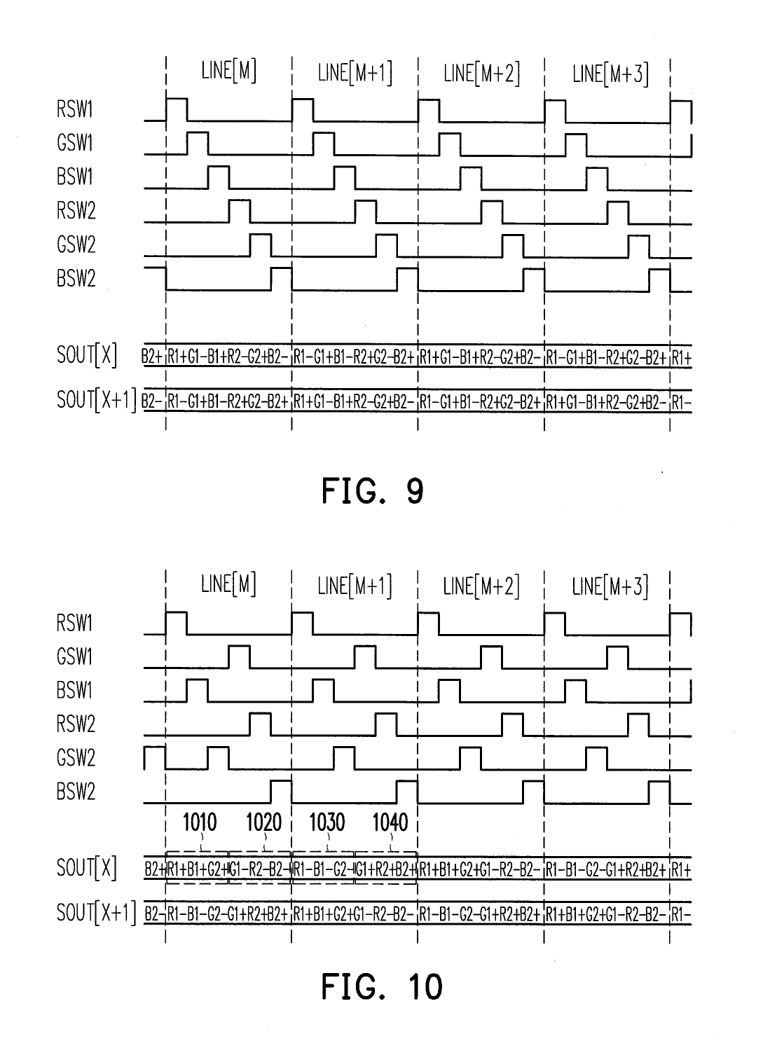

FIG. 9 is a diagram illustrating how the display panel 820 is driven through the 1-dot inversion mechanism. FIG. 10 is a diagram illustrating how the display driving device 800 works with the 1-dot inversion mechanism according to the fourth embodiment of the invention. In the conventional technique for driving a display panel with 1:6 multiplexers (as shown in FIG. 9), display data is sequentially provided to the pixel units according to the arranged sequence of the pixel units, and the display data string on the output line SOUT[X] is composed of display data (for example, the display data R1+, G1−, B1+, R2−, G2+, B2−, . . . ) of alternative polarities. Thus, the polarity inversion number of the display data is still too large and accordingly the power consumption is still very high.

In the present embodiment, the 1-dot inversion mechanism is realized by using the hardware structure illustrated in FIG. 8 and the waveforms in FIG. 10. Herein display data (for example, the display data R1+, G1−, B1+, R2−, G2+, and B2−) during the enabled period of a same scan line (for example, the scan line LINE[M]) is grouped into a positive display data set (for example, the display data set 1010 composed of positive display data R1+, B1+, and G2+) and a negative display data set (for example, the display data set 1020 composed of negative display data G1−, R2−, and B2−) of different polarities. Namely, the display data of the same polarity is arranged in adjacent time slots so that such display data of the same polarity can be sequentially transmitted.

Similarly, in the present embodiment, display data (for example, the display data R1−, G1+, B1−, R2+, G2−, and B2+) during the enabled period of the scan line LINE[M+1] is grouped into a negative display data set 1030 (composed of negative display data R1−, B1−, and G2−) and a positive display data set 1040 (composed of positive display data G1+, R2+, and B2+). Besides, the display data sets 1020 and 1030 of the display data string on the output line SOUT[X] are also both negative at where the enabled periods of the adjacent scan lines LINE[M] and LINE[M+1] meet each other.

In other words, when the display panel 820 adopts 1:6 multiplexers 830 (i.e., N=6) and the display driver 810 drives the display panel 820 through 1-dot inversion, the first display data string on the output line SOUT[X] in FIG. 10 is sequentially and repeatedly composed of display data of the first red positive polarity R1+, the first blue positive polarity B1+, the second green positive polarity G2+, the first green negative polarity G1−, the second red negative polarity R2−, and the second blue negative polarity B2− in the first scan line LINE[M].

### Fifth Embodiment

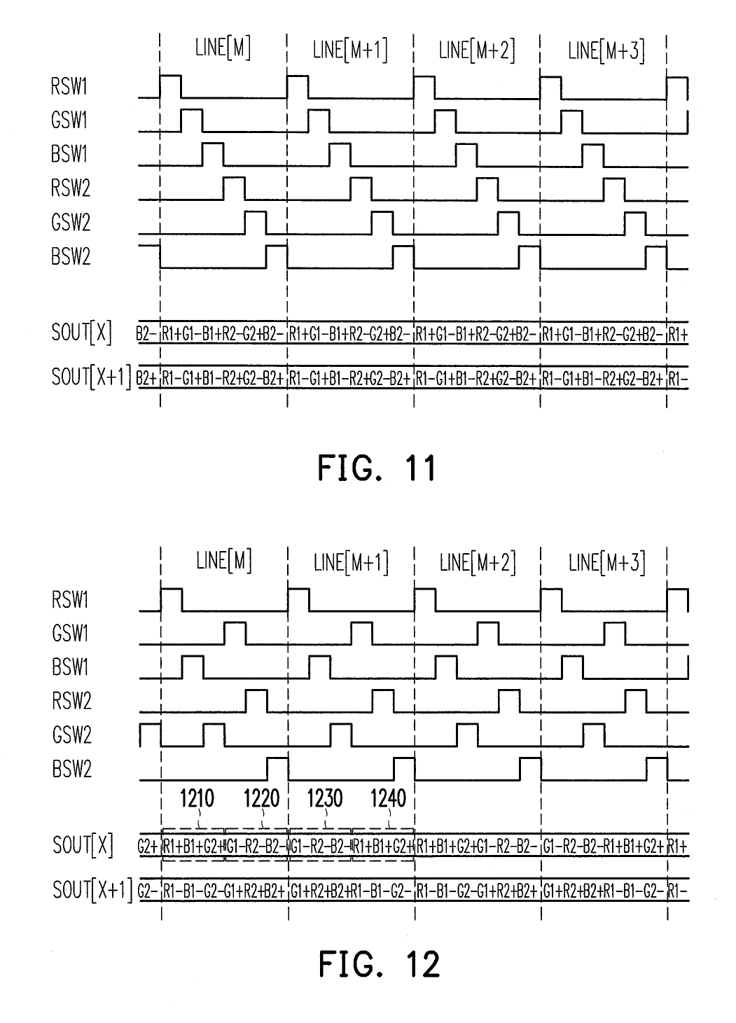

FIG. 11 is a diagram illustrating how a display panel 820 is driven through the the column inversion mechanism. FIG. 12 is a diagram illustrating how a display driving device 800 works with the column inversion mechanism according to the fifth embodiment of the invention. It should be understood by those skilled in the art that when the display panel 820 with the 1:6 multiplexers 830 is driven through column inversion, the display data strings on the output lines should be arranged in the same or similar ways of FIG. 12. Herein the waveforms in FIG. 11 are example of a conventional driving method and will not be described herein.

Referring to both FIG. 8 and FIG. 12, similar to that in the fourth embodiment described above, in the present embodiment, display data (for example, the display data R1+, G1−, B1+, R2−, G2+, and B2−) during the enabled period of a same scan line (for example, the scan line LINE[M]) is grouped into a positive display data set (for example, the display data set 1210 composed of positive display data R1+, B1+, and G2+) and a negative display data set (for example, the display data set 1220 composed of negative display data G1−, R2−, and B2−) of different polarities, so that the display data of the same polarity can be sequentially transmitted. Similarly, display data during the enabled period of the scan line LINE[M+1] is grouped into a negative display data set 1230 (composed of the negative display data G1−, R2−, and B2−) and a positive display data set 1240 (composed of the positive display data R1+, B1+, and G2+). The display data sets 1220 and 1230 of the display data string on the output line SOUT[X] are also both negative at where the enabled periods of the adjacent scan lines LINE[M] and LINE[M+1] meet each other.

### Sixth Embodiment

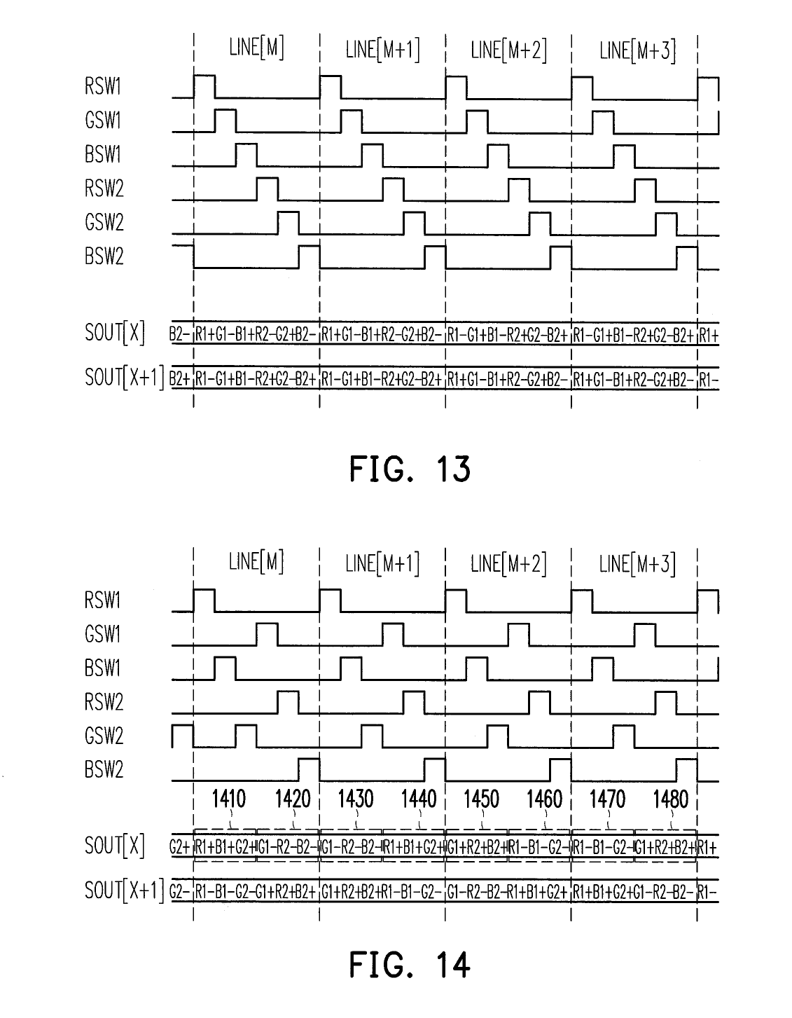

FIG. 13 is a diagram illustrating how a display panel 820 is driven through the 2-dot inversion mechanism. FIG. 14 is a diagram illustrating how a display driving device 800 works with the 2-dot inversion mechanism according to the fixth embodiment of the invention. It should be understood by those skilled in the art that when the display panel 820 with the 1:6 multiplexers 830 is driven through 2-dot inversion, the display data strings on the output lines should be arranged in the same or similar ways of FIG. 13. Herein the waveforms in FIG. 13 are example of a conventional driving method and will not be described herein.

Referring to both FIG. 8 and FIG. 14, similar to that in the fourth and fifth embodiment described above, in the present embodiment, display data (for example, the display data R1+, G1−, B1+, R2−, G2+, and B2−) during the enabled period of a same scan line (for example, the scan line LINE[M]) is grouped into a positive display data set (for example, the display data set 1410 composed of positive display data R1+, B1+, and G2+) and a negative display data set (for example, the display data set 1420 composed of negative display data G1−, R2−, and B2−) of different polarities, so that the display data of the same polarity can be sequentially transmitted. Similarly, display data during the enabled period of the scan line LINE[M+1] is grouped into a negative display data set 1430 (composed of the negative display data G1−, R2−, and B2−) and a positive display data set 1440 (composed of the positive display data R1+, B1+, and G2+). The display data sets 1420 and 1430 of the display data string on the output line SOUT[X] are also both negative at where the enabled periods of the adjacent scan lines LINE[M] and LINE[M+1] meet each other. Display data during the enabled period of the scan line LINE[M+2] is grouped into a positive display data set 1450 (composed of the positive display data G1+, R2+, and B2+) and a negative display data set 1460 (composed of the negative display data R1−, B1−, and G2−). Display data during the enabled period of the scan line LINE[M+3] is grouped into a negative display data set 1470 (composed of the negative display data R1−, B1−, and G2−) and a positive display data set 1480 (composed of the positive display data G1+, R1+, and B2+).

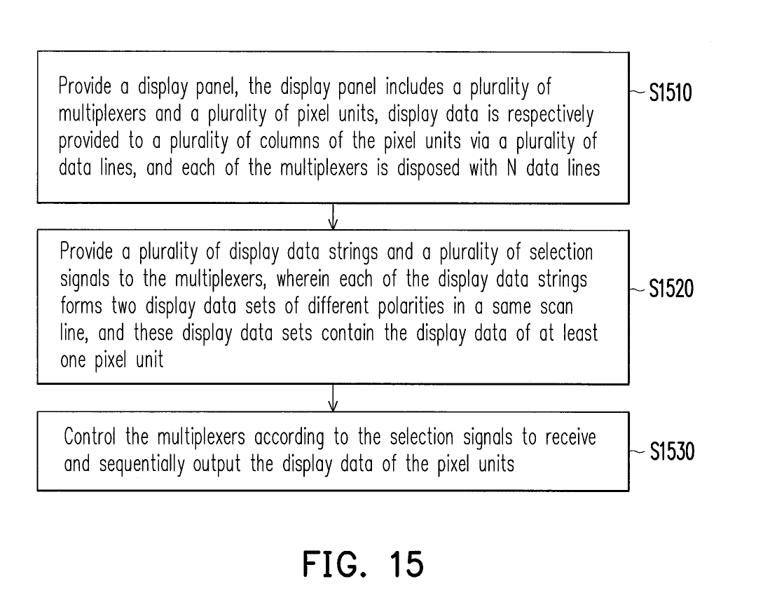

Accordingly, an embodiment of the invention provides a method for driving a display panel. FIG. 15 is a flowchart of the method for driving a display panel according to an embodiment of the invention. Referring to FIG. 15, in step S1510, a display panel is provided. The display panel includes a plurality of multiplexers and a plurality of pixel units. Display data is respectively provided to a plurality of columns of the pixel units via a plurality of data lines. Additionally, each of the multiplexers is disposed with N data lines, wherein N is a positive integer greater than or equal to 2.

In step S1520, a plurality of display data strings and a plurality of selection signals are provided to the multiplexers. Herein each of the display data strings forms two display data sets of different polarities in a same scan line, and these display data sets contain the display data of at least one pixel unit. In step S1530, the multiplexers are controlled according to the selection signals to receive and sequentially output the display data of the pixel units. The display data sets of each display data string in adjacent time slots of adjacent scan lines have the same polarity. Other aspects of the embodiment can be referred to the embodiments described above therefore will not be described herein.

As described above, in a display driving device provided by an embodiment of the invention, the type of the multiplexers and the display data driving mechanism adopted in the display panel are determined, and then the sequence of providing display data strings to the multiplexers and the startup timing of the multiplexers are re-arranged. Thereby, the display driver can be optimally adjusted for driving any type of display panel, and the polarity inversion number of the display data, and accordingly the power consumption, can be reduced when the display driver drives the pixel units.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display driving device, comprising:
a display panel, comprising:
a plurality of pixel units, wherein display data is respectively provided to a plurality of columns of the pixel units via a plurality of data lines; and
a plurality of multiplexers, wherein each of the multiplexers is disposed with N data lines, and N is a positive integer greater than or equal to 2; and
a display driver, coupled to the multiplexers, and providing a plurality of display data strings and a plurality of selection signals to the multiplexers to control the multiplexers to receive and sequentially output the display data of the pixel units according to the selection signals, wherein each of the display data strings forms two display data sets of different polarities in a same scan line, and the display data sets comprise the display data of at least one of the pixel units.

2. The display driving device according to claim 1, wherein the display data sets of each of the display data strings in adjacent time slots of adjacent scan lines have a same polarity.

3. The display driving device according to claim 1, wherein when N is 3 and the display driver drives the display panel through 1-dot inversion, a positive display data set of each of the display data strings in a first data line sequentially comprises display data of a red positive polarity and a blue positive polarity, and a negative display data set of the display data string in the first data line comprises display data of a green negative polarity.

4. The display driving device according to claim 3, wherein a negative display data set of each of the display data strings in a second data line sequentially comprises display data of a red negative polarity and a blue negative polarity, and a positive display data set of the display data string in the second data line comprises display data of a green positive polarity.

5. The display driving device according to claim 1, wherein when the display driver drives the display panel through 1-dot inversion, a first display data string sequentially comprises display data of a red positive polarity, a blue positive polarity, and a green negative polarity in a first scan line and display data of a red negative polarity, a blue negative polarity, and a green positive polarity in a second scan line.

6. The display driving device according to claim 1, wherein when N is 3 and the display driver drives the display panel through 2-dot inversion, a first display data string sequentially comprises display data of a red positive polarity, a blue positive polarity, and a green negative polarity in a first scan line, display data of the green negative polarity, the blue positive polarity, and the red positive polarity in a second scan line, display data of a green positive polarity, a blue negative polarity, and a red negative polarity in a third scan line, and display data of the red negative polarity, the blue negative polarity, and the green negative polarity in the fourth scan line.

7. The display driving device according to claim 1, wherein when N is 3 and the display driver drives the display panel through column inversion, a first display data string sequentially comprises display data of a red positive polarity, a blue positive polarity, and a green negative polarity in a first scan line and display data of the green negative polarity, the blue positive polarity, and the red positive polarity in a second scan line.

8. The display driving device according to claim 1, wherein when N is 6 and the display driver drives the display panel through 1-dot inversion, a first display data string sequentially comprises display data of a first red positive polarity, a first blue positive polarity, a second green positive polarity, a first green negative polarity, a second red negative polarity, and a second blue negative polarity in a first scan line.

9. The display driving device according to claim 1, wherein when N is 6 and the display driver drives the display panel through 2-dot inversion or column inversion, a first display data string sequentially comprises display data of a first red positive polarity, a first blue positive polarity, a second green positive polarity, a first green negative polarity, a second red negative polarity, and a second blue negative polarity in a first scan line.

10. The display driving device according to claim 9, wherein the first display data string sequentially comprises display data of the first green negative polarity, the second red negative polarity, the second blue negative polarity, the first red positive polarity, the first blue positive polarity, and the second green positive polarity in a second scan line.

11. The display driving device according to claim 10, wherein when the display driver drives the display panel through 2-dot inversion, the first display data string sequentially comprises display data of a first green positive polarity, a second red positive polarity, a second blue positive polarity, a first red negative polarity, a first blue negative polarity, and a second green negative polarity in a third scan line.

12. The display driving device according to claim 11, wherein the first display data string sequentially comprises display data of the first red negative polarity, the first blue negative polarity, the second green negative polarity, the first green positive polarity, the second red positive polarity, and the second blue positive polarity in a fourth scan line.

13. A method for driving a display panel, comprising:
providing a display panel, wherein the display panel comprises a plurality of multiplexers and a plurality of pixel units, display data is respectively provided to a plurality of columns of the pixel units via a plurality of data lines, each of the multiplexers is disposed with N data lines, and N is a positive integer greater than or equal to 2;
providing a plurality of display data strings and a plurality of selection signals to the multiplexers, wherein each of the display data strings forms two display data sets of different polarities in a same scan line, and the display data sets comprise the display data of at least one of the pixel units; and
controlling the multiplexers according to the selection signals to receive and sequentially output the display data of the pixel units.

14. The method according to claim 13, wherein the display data sets of each of the display data strings in adjacent time slots of adjacent scan lines have a same polarity.
